(19) United States
(12) Patent Application Publication
(10) Pub. No.: US 2018/0255230 A1
(43) Pub. Date: Sep. 6, 2018

(54) ACTUATOR DRIVER, IMAGE PICKUP APPARATUS, AND ELECTRONIC DEVICE

(71) Applicant: ROHM CO., LTD., Ukyo-ku Kyoto (JP)

(72) Inventor: Tatsuro SHIMIZU, Ukyo-ku Kyoto (JP)

(21) Appl. No.: 15/911,988

(22) Filed: Mar. 5, 2018

(30) Foreign Application Priority Data
Mar. 6, 2017 (JP) 2017-041911

(51) Int. Cl. H04N 5/232; G03B 3/10; H04N 5/225

(52) U.S. Cl. CPC H04N 5/23212; H04N 5/2254; G03B 3/10

(57) ABSTRACT

An actuator driver used in an image pickup apparatus includes: an image pickup element; a lens installed on an incident optical path to the image pickup element; an actuator configured to cause a displacement of the lens; a position detection element configured to generate a position detection signal representing the displacement of the lens; and the actuator driver configured to perform feedback control of the actuator on the basis of a target code, which represents a target displacement of the lens, and the position detection signal, the actuator driver including: a correction circuit configured to convert a first detection code according to the position detection signal into a second detection code having a linear relationship with respect to an actual displacement of the lens; and a control circuit configured to control the actuator such that the second detection code approximates the target code.

### CROSS-REFERENCE TO RELATED APPLICATION

This application is based upon and claims the benefit of priority from Japanese Patent Application No. 2017-041911, filed on Mar. 6, 2017, the entire contents of which are incorporated herein by reference.

### TECHNICAL FIELD

The present disclosure relates to an image pickup apparatus.

### BACKGROUND

Recently, a camera module, mounted to a smart phone or the like, has an Auto Focus (AF) function. A camera module having an AF function causes the displacement of a lens, installed between an image pickup element and a subject, in an optical axis direction (Z-axis) such that an image of the subject is formed on the surface (image pickup plane) of the image pickup element.

FIG. 1 is a block diagram of a camera module having an AF function. The camera module 100 includes an image pickup element 102, a lens 104, an actuator 106, an actuator driver 108, a position detection element 110, and a Central Processing Unit (CPU) 114.

The image pickup element 102 captures an image having passed through the lens 104. The CPU 114 generates a target code D₁ representing a target value of the displacement of the lens 104. The actuator driver 108 generates a driving signal S₅ for the actuator 106 on the basis of the target code D₁. The actuator 106 determines a position of the lens 104 according to the driving signal S₅.

The camera module having the AF function needs to accurately determine a position of the lens 104, and thus uses feedback control (closed-loop control). The position detection element 110 generates a position detection signal S₂ representing the displacement of the lens 104. The actuator driver 108 performs feedback control of a driving signal S₅ such that the position of the lens 104 represented by the position detection signal S₂ coincides with a target position represented by the target code D₁.

### SUMMARY

FIG. 2A is a view illustrating a relationship between an actual displacement of the lens 104 and a position detection signal S₂. FIG. 2B is a view illustrating a relationship between a target code D₁ and a displacement of the lens 104.

The camera module 100, mounted to a smart phone or a tablet personal computer, is required to be miniaturized and made thin, and thus has many limitations on the sizes and layout of constituent components within the camera module 100. In these circumstances, as illustrated in FIG. 2A, a position detection signal S₂ generated by the position detection element 110 is non-linear with respect to an actual displacement of the lens 104.

As described above, the actuator driver 108 drives the actuator 106 such that the target code D₁ coincides with a value of a position detection signal S₂. As a result, as illustrated in FIG. 2B, the lens 104 cannot be linearly controlled with respect to the target code D₁.

The present disclosure has been made in view of the above-described circumstances, the present disclosure provides some embodiments of an actuator driver capable of linearly controlling a lens with respect to a target code.

According to an embodiment of the present disclosure, an actuator driver used in an image pickup apparatus is provided. The image pickup apparatus includes: an image pickup element; a lens installed on an incident optical path to the image pickup element; an actuator configured to cause a displacement of the lens; a position detection element configured to generate a position detection signal representing the displacement of the lens; and the actuator driver configured to perform feedback control of the actuator on the basis of a target code, which represents a target displacement of the lens, and the position detection signal. The actuator driver includes: a correction circuit configured to convert a first detection code according to the position detection signal into a second detection code having a linear relationship with respect to an actual displacement of the lens; and a control circuit configured to control the actuator such that the second detection code approximates the target code.

According to the embodiment of the present disclosure, a linear displacement of the lens may be caused with respect to the target code.

When an ideal characteristic of a value x of the target code and a value y of the displacement of the lens corresponds to y=f(x) and a relationship between a value z of the first detection code and the value y of the displacement of the lens corresponds to y=g(z), the correction circuit may generate a value of the second detection code, according to a conversion characteristic expressed by x=f¹(g(z)).

The correction circuit may include a look-up table configured to store a corresponding relationship between the first detection code and a difference between the first detection code and the second detection code. By this configuration, a capacity of the look-up table may be reduced.

The look-up table may be configured to store values of corresponding differences with respect to multiple representative values of the first detection code. By this configuration, the capacity of the look-up table may be reduced.

The correction circuit may include a look-up table configured to store a corresponding relationship between the first detection code and the second detection code. The look-up table may be configured to store values of the corresponding second detection code with respect to multiple representative values of the first detection code.

According to another embodiment of the present disclosure, an actuator driver used in an image pickup apparatus is provided. The image pickup apparatus includes: an image pickup element; a lens installed on an incident optical path to the image pickup element; an actuator configured to cause a displacement of the lens; a position detection element configured to generate a position detection signal representing the displacement of the lens; and the actuator driver configured to perform feedback control of the actuator on the basis of a first target code, which represents a target displacement of the lens, and the position detection signal. The actuator driver includes: a correction circuit configured to convert the first target code into a second target code; and a control circuit configured to control the actuator such that a detection code according to the position detection signal approximates the second target code. A characteristic of the converting of the first target code into the second target code is prescribed to cause a linear displacement of the actuator with respect to the first target code.

When a relationship between a value z of the detection code and the displacement y of the lens corresponds to y=g(z), the correction circuit may use an inverse function of y=g(z) to generate a value x′ of the second target code, according to a conversion characteristic expressed by x′=g⁻¹(x).

The correction circuit may include a look-up table configured to store a corresponding relationship between the second target code and a difference between the second target code and the first target code.

The actuator driver may be integrally integrated on one substrate.

The configuration “integral integration” may include a case where all elements of a circuit are formed on a substrate or main elements thereof are integrated on the substrate, wherein, in order to adjust a circuit constant, some resistors, capacitors, or the like may be installed outside the substrate. By integrating a circuit on one chip, an area of the circuit can be reduced, and characteristics of elements of the circuit can be uniformly maintained.

According to another embodiment of the present disclosure, an image pickup apparatus is provided. The image pickup apparatus includes: an image pickup element; a lens installed on an incident optical path to the image pickup element; an actuator configured to cause a displacement of the lens; a position detection element configured to generate a position detection signal representing the displacement of the lens; and one of the above-described actuator drivers configured to perform feedback control of the actuator on the basis of a target code, which represents a target displacement of the lens, and the position detection signal.

According to another embodiment of the present disclosure, an electronic device is provided. The electronic device includes the above-described image pickup apparatus.

Further, any combination of the above-described elements and those obtained by mutual replacement of elements or representations of the present disclosure among methods, apparatuses, systems, and others are effective as modes of the present disclosure. Moreover, the embodiments described in this disclosure do not describe all non-essential features, and thus, sub-combinations of the described features may also be used.

### BRIEF DESCRIPTION OF THE DRAWINGS

FIG. 1 is a block diagram of a camera module having an AF function;

FIG. 2A is a view illustrating a relationship between an actual displacement of a lens and a position detection signal, and FIG. 2B is a view illustrating a relationship between a target code and a displacement of a lens;

FIG. 3 is a block diagram of a camera module according to a first embodiment;

FIGS. 4A to 4C are views for explaining correction processing;

FIG. 5 is a view for explaining calibration of a camera module;

FIG. 6 is a view illustrating a configuration example of a correction circuit;

FIGS. 7A and 7B are views for explaining a reduction in capacity of a look-up table;

FIG. 8 is a view illustrating another configuration example of a correction circuit;

FIG. 9 is a block diagram of a camera module according to a second embodiment; and

FIG. 10 is a view illustrating an electronic device including a camera module.

### DETAILED DESCRIPTION

Hereinafter, embodiments of the present disclosure will be described with reference to the accompanying drawings. Identical reference numerals are given to identical or equivalent elements, members, or processing procedures illustrated in the drawings, and repetitive descriptions thereof will be appropriately omitted. Also, embodiments do not limit the scope of the present disclosure but describe the present disclosure by way of example, and all of the features and the combinations thereof described in the embodiments are not necessarily essential to the present disclosure.

Further, the dimensions (thicknesses, lengths, widths, etc.) of members illustrated in each drawing may be appropriately enlarged or reduced to facilitate the understanding of the present disclosure. Further, the dimensions of multiple members are not necessarily limited to the expression of a size relationship between the multiple members. Therefore, in the drawings, although a certain member A is illustrated as being thicker than a different member B, the member A may be thinner than the member B.

In this specification, a “state where a member A is connected to a member B” includes not only a case where the member A is physically and directly connected to the member B, but also a case where the member A is indirectly connected to the member B through another member that either does not substantially affect an electrically-connected state between the members A and B or does not impair a function or effect exerted by a combination of the members A and B.

Similarly, a “state where a member C is interposed between the member A and the member B” includes not only a case where the member A is directly connected to the member C or the member B is directly connected to the member C, but also a case where the member A is indirectly connected to the member C or the member B is indirectly connected to the member C through another member that either does not substantially affect an electrically-connected state between the members A and C or B and C or does not impair a function or effect exerted by a combination of the members A and C or B and C.

### First Embodiment

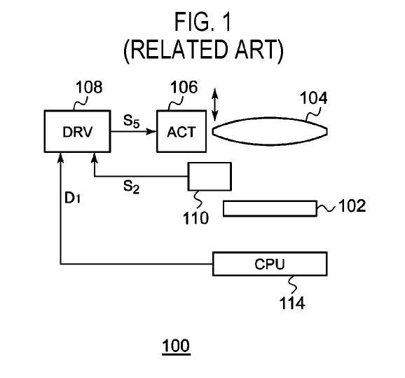

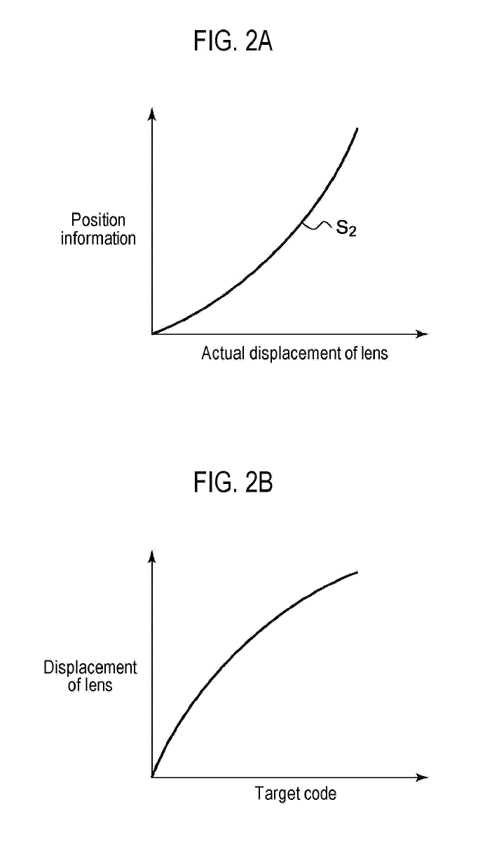

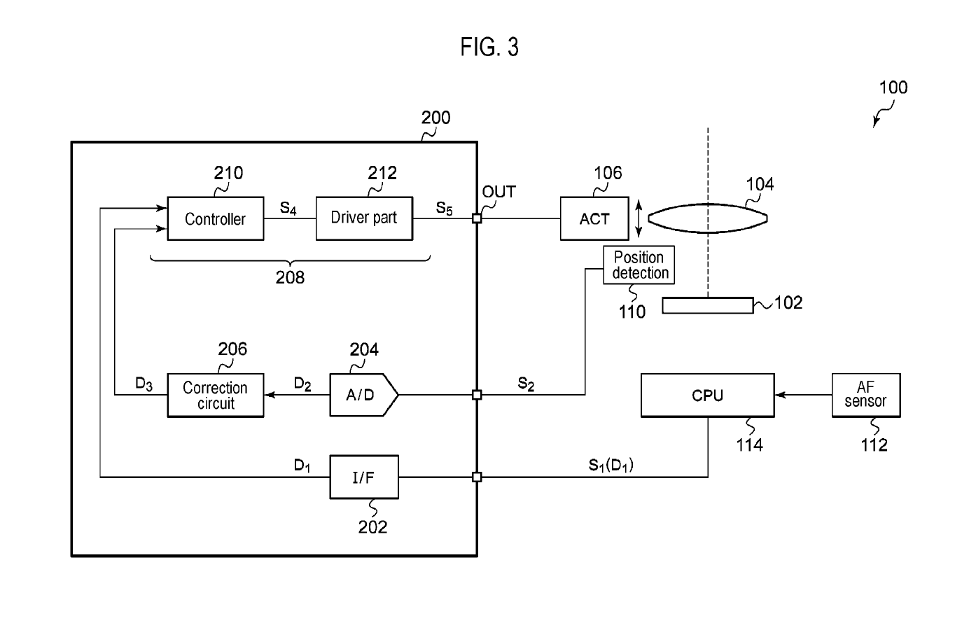

FIG. 3 is a block diagram of a camera module 100 according to a first embodiment. A basic configuration of the camera module 100 illustrated in FIG. 3 is similar to that of the camera module illustrated in FIG. 1. A lens 104 is installed on an incident optical path to an image pickup element 102. An actuator 106 causes the displacement of the lens 104 in an optical axis direction. A position detection element 110 is a magnetic sensor, which may be a Hall sensor and the like, and generates a position detection signal (a hall signal) S₂ representing the displacement of the lens 104. An AF sensor 112 detects information required for focusing on the basis of a phase difference detection scheme or a contrast detection scheme.

A CPU 114 generates serial data S₁ including a target code D₁ representing a target value of the displacement of the lens 104 on the basis of an output of the AF sensor 112. An actuator driver 200 generates a driving signal S₅ for the actuator 106 on the basis of the target code D₁. The lens 104 is installed at a mover of the actuator 106, and the lens 104 moves to a position according to the target code D₁.

More specifically, the actuator driver 200 performs feedback control of the actuator 106 on the basis of the target code D₁, which represents a target displacement of the lens 104, and a position detection signal S₂.

The actuator driver 200 includes an interface circuit 202, an Analog-to-Digital (A/D) converter 204, a correction circuit 206, and a control circuit 208. The interface circuit 202 receives, from the CPU 114, serial data S₁ including the target code D₁. The A/D converter 204 converts a position detection signal S₂, which is output from the position detection element 110, into a first detection code D₂ in a digital form. An amplifier may be installed in front of the A/D converter 204. When a position detection signal S₂ is a digital signal, the A/D converter 204 may be omitted.

The correction circuit 206 converts the first detection code D₂ into a second detection code D₃ having a linear relationship with respect to an actual displacement of the lens 104. The control circuit 208 controls the actuator 106 such that the second detection code D₃ approximates the target code D₁. The control circuit 208 includes a controller 210 and a driver part 212. The controller 210 generates a control command value S₄ such that an error between the second detection code D₃ and the target code D₁ approximates zero. The driver part 212 supplies the actuator 106 with a driving signal S₅ according to the control command value S₄.

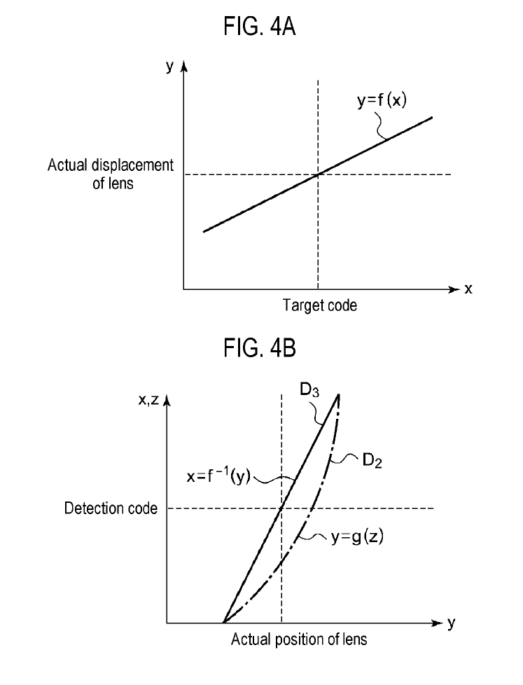

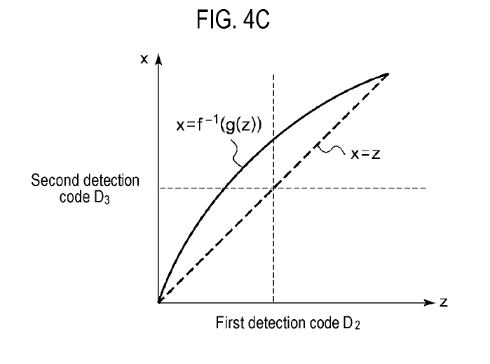

Hereinabove, the overall configuration of the camera module 100 has been described. Next, correction processing of the correction circuit 206 will be described. FIGS. 4A to 4C are views for explaining correction processing.

FIG. 4A is a view illustrating an actual displacement of the lens 104 and the first detection code D₂. When viewed from CPU 114, a relationship which needs to be established between the target code D₁ and an actual displacement of the lens 104 is prescribed, as an ideal characteristic, by Equation (1):

y=f(x) (1)

In Equation (1), y represents displacement and x represents code.

When a servo is applied, feedback is performed such that the target code D₁ coincides with the second detection code D₃. Accordingly, Equation (1) may also be established between x representing the second detection code D₃ and y representing an actual displacement of the lens 104. In other words, the second detection code D₃ expressed as a function of an actual displacement is defined by Equation 2:

x=f¹(y) (2)

When viewed from CPU 114, an ideal characteristic, which needs to be established between the target code D1 and an actual displacement of the lens 104, may be linear and thus, Equations (3) and (4) below are obtained.

y=f(x)=ax+b (3)

x=(y−b)/a (4)

Equations (3) and (4) are illustrated in FIGS. 4A and 4B, respectively.

FIG. 4B illustrates a relationship between an actual position of a lens and the first detection code D₂ corresponding thereto. Due to an effect of a detection error of the position detection element 110, the first detection code D₂ is non-linear with respect to an actual position of the lens. A relationship between a value z of the first detection code D₂ and an actual position y of the lens is expressed by Equation (5) below.

y=g(z) (5)

Equation (5) may be measured as described below.

When Equation (5) is substituted into Equation (2), Equation (6) below is obtained.

x=f⁻¹(y)=f⁻¹(g(z)) (6)

Equation (6) expresses a corresponding relationship between the first detection code D₂ and the second detection code D₃. FIG. 4C illustrates a corresponding relationship (hereinafter referred to as a “correction characteristic”) between the first detection code D₂ and the second detection code D₃.

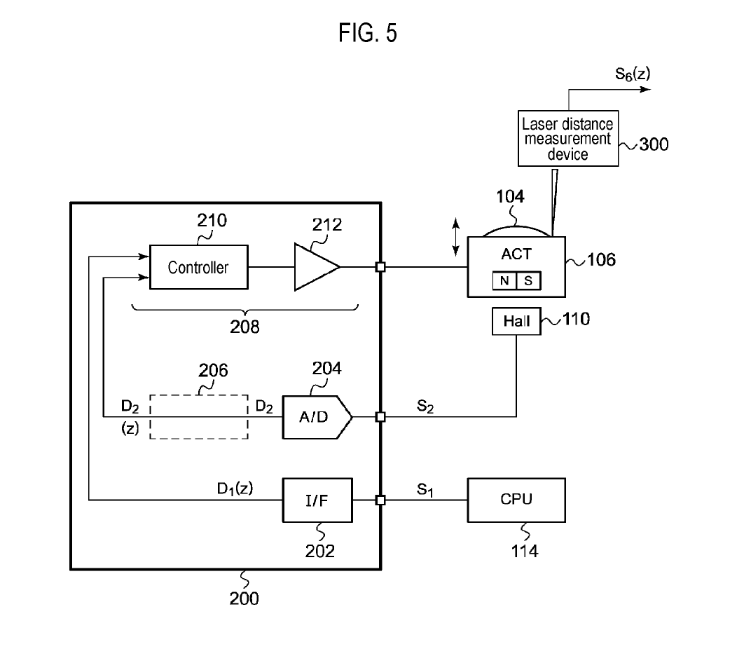

FIG. 5 is a view for explaining calibration of the camera module 100. When the camera module 100 is set up, the correction circuit 206 is nullified, and the first detection code D₂ is input, as is, to the controller 210 (D₃=D₂). In this state, the CPU 114 sweeps the target code D₁ and causes the displacement of the lens 104. The displacement of the lens 104 at this time is measured by a measurement device 300 which may be a laser distance measurement device and the like. An output S₆ of the measurement device 300 is a value y representing a displacement.

For each value of the target code D₁, y representing a displacement and an output (a value z of the first detection code D₂) of the A/D converter 204 are acquired. A relationship between the value z of the first detection code D₂ and the actual displacement y, which are acquired by the measurement, corresponds to Equation (5).

Further, in a state where the correction circuit 206 is nullified, the servo is applied such that the target code D1 becomes equal to the first detection code D₂, and thus, D₁ and D₂ may be regarded as being D₁=D₂=z. Accordingly, a corresponding relationship between the target code D1 and an output y of the measurement device 300 may be acquired.

From the ideal characteristic expressed by Equation (1) and y=g(z) expressing the corresponding relationship obtained by the measurement, a conversion characteristic expressed by Equation (6) may be derived. Several variations exist of a method for generating and using the conversion characteristic. One method uses a look-up table and another method uses an approximate expression.

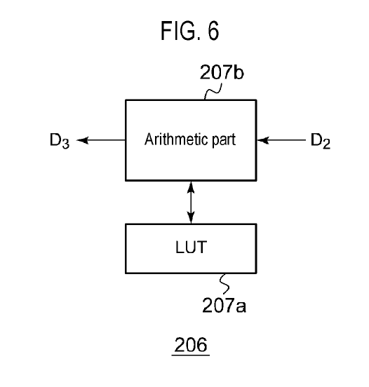

FIG. 6 is a view illustrating a configuration example of the correction circuit 206. By making reference to a table, the correction circuit 206 illustrated in FIG. 6 converts the first detection code D₂ into the second detection code D₃. Values of the output code D₃ are stored in a look-up table 207a so as to respectively correspond to the values of input code D₂. An arithmetic part 207b reads the output code D₃, which corresponds to the input code D₂, from the look-up table 207a and outputs the same.

When the values of output code D₃ are stored, as they are, so as to respectively correspond to all the values of input code D₂, a large capacity of memory is required. For example, when each of the value z of D₂ and the value x of D₃ is expressed using 32769 gradations from −16384 to 16384, each of D₂ and D₃ becomes binary data of 15 bits 2 bytes. The capacity of the look-up table 207a is 2 bytes×32769=65538 bytes=64 kilobytes.

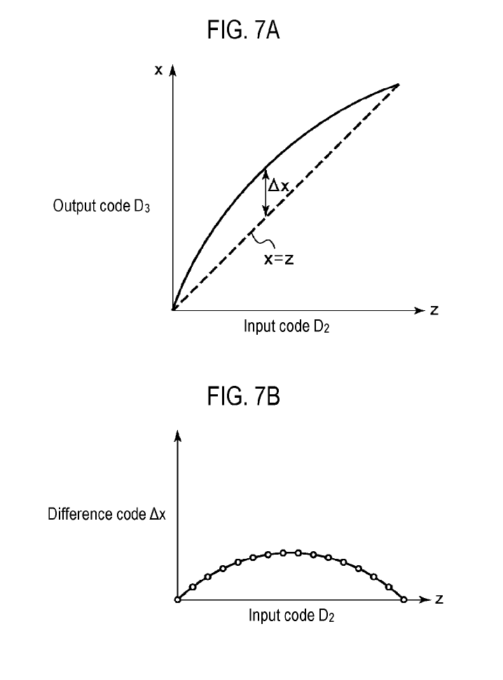

FIGS. 7A and 7B are views for explaining a reduction in capacity of the look-up table 207a. When the capacity of a memory is limited, a corresponding relationship between D₂ and (D₃−D₂) may be stored in the memory. (D₃−D₂) may be expressed to have the number of bits smaller than 15 bits. When it is possible to express (D₃−D₂) so as to have 4 bits, the capacity of the look-up table 207a may become 0.5 byte×32769=16 kilobytes, and thus may be compressed to a fourth of the capacity when each of D₂ and D₃ becomes binary data of 15 bits.

The correction circuit 206 may read a difference code Δx corresponding to an input code D₂, and may generate an output code D₃ according to an arithmetic operation:

D₃=D₂+Δx

In order to further save the capacity of the memory, only for some (e.g., 16) representative values (represented by white circle symbols in FIG. 7B) instead of all the values of the input code D₂, difference codes Ax are stored in the look-up table 207a, and difference codes Ax between representative values may be generated by interpolation. In this case, the capacity of the memory may be compressed to:

2 bytes×16=32 bytes

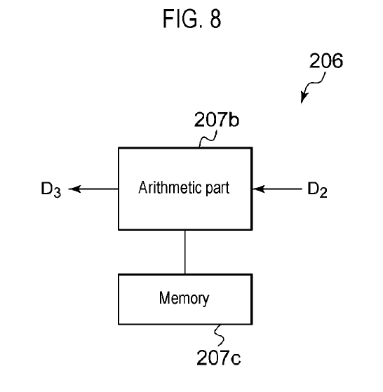

FIG. 8 is a view illustrating another configuration example of the correction circuit 206. The correction circuit 206 illustrated in FIG. 8 converts an input code D₂ into an output code D₃ by using an approximate expression. Parameters prescribing the approximate expression are stored in a memory 207c. Polynomial approximation and the like may be used for approximation, but the present disclosure is not limited thereto.

For example, polynomial approximation may be applied to a relational expression (conversion characteristic) between D₂ and D₃ expressed by FIG. 7A and Equation (6).

x=a₀+a₁z+a₂z²+a₃z³+ . . . +aₙzⁿ (7)

In Equation (6), ao to an represent coefficients and are stored in the memory 207c. The order of approximation is not specially limited.

The arithmetic part 207b calculates a value x of the output code D₃ from a value z of the input code D₂ on the basis of Equation (7).

Polynomial approximation may be applied to a difference code Δx expressed in FIG. 7B.

Δx=b₀+b₁z+b₂z²+b₃z³+ . . . +bₙzⁿ (8)

In this case, the arithmetic part 207b calculates a value x of an output code D₃ from a value z of an input code D₂ on the basis of Equation (9).

x=z+Δx=z+b₀+b₁z+b₂z²+b₃z³+ . . . +bₙzₙ

In order to improve the accuracy of approximation, the input code D₂ may be divided to be included in multiple ranges, and different approximate expressions may be prescribed for the respective ranges.

### Second Embodiment

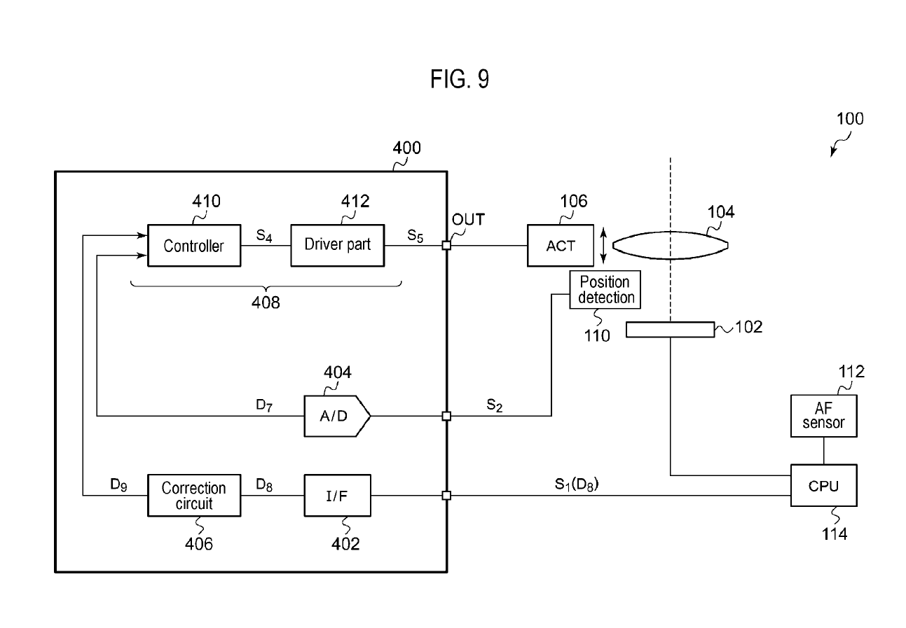

FIG. 9 is a block diagram of a camera module 100 according to a second embodiment. Hereinafter, the difference of the second embodiment from the first embodiment will be described.

A CPU 114 generates serial data Si, which includes a first target code D₈ representing a target value of the displacement of a lens 104, on the basis of an output of an AF sensor 112. An actuator driver 400 generates a driving signal S₅ for an actuator 106 on the basis of the first target code D₈. The lens 104 is installed at a mover of the actuator 106, and moves to a position according to the first target code D₈.

More specifically, the actuator driver 400 performs feedback control of the actuator 106 on the basis of a first target code D₈, which represents a target displacement of the lens 104, and a position detection signal S₂.

The actuator driver 400 includes an interface circuit 402, an A/D converter 404, a correction circuit 406, and a control circuit 408. The interface circuit 402 receives the serial data S₁, which includes the first target code D₈, from the CPU 114. The A/D converter 404 converts a position detection signal S₂, which is output from a position detection element 110, into a detection code D₇ in digital form. When a position detection signal S₂ is a digital signal, the A/D converter 404 may be omitted.

The correction circuit 406 converts the first target code D₈ into a second target code D₉. The control circuit 408 performs feedback control of the actuator 106 such that the detection code D₇ approximates a second target code D₉. The correction circuit 406 includes a controller 410 and a driver part 412. The controller 410 generates a control command value S₄ such that an error between the detection code D₇ and the second target code D₉ approximates zero. The driver part 412 supplies the actuator 106 with a driving signal S₅ according to the control command value S₄.

Characteristics of the conversion of the first target code D₈ into the second target code D₉ in the correction circuit 406 are prescribed such that a linear displacement of the actuator 106 is caused with respect to the first target code D₈.

Characteristics of the conversion of the first target code D₈ into the second target code D₉ may be determined as described below. A relationship between a value z of the detection code D₇ and a value y of an actual displacement D₇ of the lens 104 is y=g(z). When an inverse function of the function g is g⁻¹, an expression for conversion of a value x of a first target code D8 into a value x′ of a second target code D₉ may be

x′=g⁻¹(x)

That is, the same distortion as a distortion given by the position detection element 110 is given to a first target code D₈, so that linearity between the first target code D₈ and the actual displacement of the lens 104 can be improved.

### Use

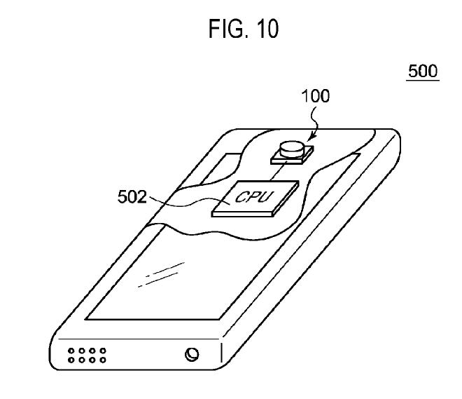

Lastly, the use of the camera module 100 will be described. FIG. 10 is a view illustrating an electronic device 500 including the camera module 100. The electronic device 500 illustrated in FIG. 10 is a smart phone, and includes the above-described camera module 100 and a main CPU 502. The main CPU 502 is a processor that controls the entire electronic device 500. The main CPU 502 monitors a user's control input to the electronic device 500, and instructs the camera module 100 to perform an AF operation, a shutter operation, and the like. The electronic device 500 may be a tablet terminal, a laptop computer, a desktop computer, a portable audio player, and the like.

According to the present disclosure, it is possible to cause a linear displacement of a lens with respect to a target code.

While certain embodiments have been described, these embodiments have been presented by way of example only, and are not intended to limit the scope of the disclosures. Indeed, the novel methods and apparatuses described herein may be embodied in a variety of other forms; furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. An actuator driver used in an image pickup apparatus, the image pickup apparatus comprising:
an image pickup element;
a lens installed on an incident optical path to the image pickup element;
an actuator configured to cause a displacement of the lens;
a position detection element configured to generate a position detection signal representing the displacement of the lens; and
the actuator driver configured to perform feedback control of the actuator on the basis of a target code, which represents a target displacement of the lens, and the position detection signal,
the actuator driver including:
a correction circuit configured to convert a first detection code according to the position detection signal into a second detection code having a linear relationship with respect to an actual displacement of the lens; and
a control circuit configured to control the actuator such that the second detection code approximates the target code.

2. The actuator driver of claim 1, wherein, when an ideal characteristic of a value x of the target code and a value y of the displacement of the lens corresponds to y=f(x) and a relationship between a value z of the first detection code and the value y of the displacement of the lens corresponds to y=g(z), the correction circuit generates a value of the second detection code, according to a conversion characteristic expressed by
x=f⁻¹(g(z)).

3. The actuator driver of claim 2, wherein the correction circuit comprises a look-up table configured to store a corresponding relationship between the first detection code and a difference between the first detection code and the second detection code.

4. The actuator driver of claim 3, wherein the look-up table is configured to store values of corresponding differences with respect to multiple representative values of the first detection code.

5. The actuator driver of claim 2, wherein the correction circuit comprises a look-up table configured to store a corresponding relationship between the first detection code and the second detection code.

6. The actuator driver of claim 5, wherein the look-up table is configured to store values of the second detection code that corresponds with multiple representative values of the first detection code.

7. An actuator driver used in an image pickup apparatus, the image pickup apparatus comprising:
an image pickup element;
a lens installed on an incident optical path to the image pickup element;
an actuator configured to cause a displacement of the lens;
a position detection element configured to generate a position detection signal representing the displacement of the lens; and
the actuator driver configured to perform feedback control of the actuator on the basis of a first target code, which represents a target displacement of the lens, and the position detection signal, the actuator driver including:
a correction circuit configured to convert the first target code into a second target code; and
a control circuit configured to control the actuator such that a detection code according to the position detection signal approximates the second target code,
wherein a characteristic of the converting of the first target code into the second target code is prescribed to cause a linear displacement of the actuator with respect to the first target code.

8. The actuator driver of claim 7, wherein, when a relationship between a value z of the detection code and the displacement y of the lens corresponds to y=g(z), the correction circuit may use an inverse function of y=g(z) to generate a value x′ of the second target code, according to a conversion characteristic expressed by x′=g⁻¹(x).

9. The actuator driver of claim 8, wherein the correction circuit comprises a look-up table configured to store a corresponding relationship between the second target code and a difference between the second target code and the first target code.

10. The actuator driver of claim 1, wherein the actuator driver is integrally integrated on one substrate.

11. An image pickup apparatus comprising:
an image pickup element;
a lens positioned on an incident optical path to the image pickup element;
an actuator configured to cause a displacement of the lens;
a position detection element configured to generate a position detection signal representing the displacement of the lens; and
the actuator driver of claim 1, configured to perform feedback control of the actuator on the basis of a target code, which represents a target displacement of the lens, and the position detection signal.

12. An electronic device comprising the image pickup apparatus as claimed in claim 11.
